(19) United States
(12) Patent Application Publication
(10) Pub. No.: US 2024/0073720 A1
(43) Pub. Date: Feb. 29, 2024

(54) FIRST NODE AND METHODS PERFORMED THEREBY FOR HANDLING ANOMALOUS VALUES

(71) Applicant: Telefonaktiebolaget LM Ericsson (publ), Stockholm (SE)

(72) Inventors: Ebenezer RHP ISAAC, Chennai (IN); Prashant BHARGAVA, Athlone (IE); Venkata Geeta Madhavi GOTTUMUKKALA, Athlone Co. Westmeath (IE)

(21) Appl. No.: 18/270,098

(22) PCT Filed: Jun. 25, 2021
(86) PCT No.: PCT/SE2021/050634

§ 371 Date: Jun. 28, 2023

(51) Int. Cl. H04W 24/08; G06F 17/18

(52) U.S. Cl. CPC H04W 24/08; G06F 17/18

(57) ABSTRACT

A method, performed by a first node. The method is for handling anomalous values. The first node determines whether an anomalous value is present in a first distribution of values (M) over a first time period. The values are indicative of a performance of a communications system. The first distribution has a first variability per time point. The determining including defining a subset of second time periods within the first time period. The second time periods are equally spaced in time. The determining including determining a second variability of a second distribution (S) of a subset of the values corresponding to the subset of second periods. The determining further including detecting the presence of the anomalous value according to a threshold, based on a variation along time of the second variability. The first node also provides a result of the determination.

### TECHNICAL FIELD

The present disclosure relates generally to a first node and methods performed thereby, for handling anomalous values. The present disclosure also relates generally to a computer programs and computer-readable storage mediums, having stored thereon the computer programs to carry out these methods.

### BACKGROUND

Computer systems in a communications network may comprise one or more nodes, which may also be referred to simply as nodes. A node may comprise one or more processors which, together with computer program code may perform different functions and actions, a memory, a receiving port and a sending port. A node may be, for example, a server. Nodes may perform their functions entirely on the cloud.

### Anomaly Detection

The performance of a communications network may be measured by the analysis of data indicating its performance, such as, for example, Key Performance Indicators (KPIs). To be able to assess the performance of the communications network, it may therefore be useful to identify if there may be data that may deviate from the norm, or from the expected value, which may be implemented by analyzing the presence of outlier or anomalous data. Generally, the terms outliers and anomalies may be used interchangeably. However, they may differ when considered in a business context. An outlier may be understood as a rare occurrence that may differ significantly from the majority of data under observation, whereas an anomaly may be understood as a significant deviation from the expected occurrence. Not all data points that are outliers may conform as anomalies; it may depend on the use case. For example, if the number of active uplink users are measured, there may be a peak in the number of uplink users during a tournament sports event, that may considerably deviate from the mean number of uplink users. While, statistically, this peak may be considered an outlier value, from a use case perspective, it may not be considered an anomaly. Hence, outlier detection may be understood to look at data from a statistical standpoint, while Anomaly Detection (AD) may be understood to consider it from a use case perspective.

When it comes to time series, AD may become even more of a challenge due to seasonality and trend [1]. Seasonality may be understood as a property of a time series data that may cause the data to exhibit different ranges at different parts of a period. The period may be of any granularity such as day, week, month or even a year. Trend may be understood as the upward or downward movement of averages across a certain timeframe.

An AD pipeline for time series data is depicted in FIG. 1. A common AD pipeline may begin by selecting the features that may be required for the use case, that is, the features from the data that may relate to the anomalies under consideration may be selected for processing. The preprocessing step may involve feature engineering and then removal of seasonal components through seasonal decomposition such as Seasonal and Trend decomposition using Locally Estimated Scatterplot Smoothing (STL) [2]. One the selected feature may have been preprocessed, it may be passed through an outlier detector, that is, it may be fed to the outlier detection algorithm, which may return scores. Generally, an outlier detector may provide scores on top of which a threshold may be set to determine outliers, and to flag anomalies. These flags may be filtered by some heuristic or hard-coded rules according to the use case, to report the final anomalies.

Existing AD methods, such as Seasonal Auto Regressive Integrated Moving Average (ARIMA) [3, 4], Holt-Winters [5], and STL may be understood to attempt to break down two or more time series components [6] by computing separate parameters for each of the decomposed components, in order to detect anomalies that are not affected by either trend or seasonality, e.g., that are not affected by the time of the day, etc. . . . . A time series component. These components may be understood to be secular trend, seasonal variations, cyclic fluctuations and irregular variations. Trend may be understood as a direction in which the time series may be moving, it may be upward or downward. Seasonal variations may be understood as certain observed patterns in a time series that may be affected by some aspects of the calendar/time, such as the ‘time of the day’. Cyclic fluctuations may be understood as again rise and fall in a time series of data, without any fixed period. Irregular variations may be understood as variations that may be affected by external aspects such as an event which may cause an unexpected surge in network traffic. After decomposition, whereby seasonality, trends and variations may be identified and removed from the time series, the difference between the forecasted values and the observed values may be considered to be Independent and Identically Distributed (IID), which may then be sent to a standard anomaly detector to follow the rest of the AD pipeline.

### SUMMARY

Although the existing methods do well in addressing the challenge of accurate forecasting network KPIs in certain conditions, they suffer from the following drawbacks. First, they do not address time-varying range estimation. In a typical Key Performance Indicator (KPI), such as downlink traffic for a cell, the expected values may be higher around midday and lower around midnight. The expected range of the irregular variation may also vary periodically, in the same manner. This phenomenon is not captured by the existing forecasting systems, as they tend to assume constant deviation across the day. Second, a standard decomposition algorithm may be understood to require hyperparameter tuning, and hyperparameter tuning is non-trivial. Hyperparameter tuning may be understood as a process of choosing a set of optimal parameters for an algorithm. Tuning each parameter for a standard decomposition algorithm is not simple. Some existing methods may even resort to a brute-force grid search for the same, that is, with testing the performance of the algorithm with all combinations of an exhaustive list of possible tuning parameter values, which incurs significant computational cost. For example, depending on the data, even a small deviation in any of the 4 parameters in Seasonal ARIMA may lead to a greater error in forecasting.

It is an object of embodiments herein to improve the handling of anomalous values.

According to a first aspect of embodiments herein, the object is achieved by a computer-implemented method performed by a first node. The method is for handling anomalous values. The first node determines whether or not an anomalous value is present in a first distribution of values (M) over a first time period. The values are indicative of a performance of a communications system. The first distribution has a first variability per time point. The determining comprises i) defining a subset of second time periods within the first time period. The second time periods in the subset are equally spaced in time over the first time period. The determining further comprises ii) determining a second variability of a second distribution (S) of a subset of the values. The subset of the values corresponds to the defined subset of second periods. The determining also comprises v) detecting the presence of the anomalous value according to a threshold, based on a variation along time of the second variability. The first node then provides a result of the determination of whether or not the anomalous value is present in the first distribution of values.

According to a second aspect of embodiments herein, the object is achieved by the first node. The first node is for handling anomalous values. The first node is configured to determine whether or not an values is present in the first distribution of values (M) over the first time period. The values are configured to be indicative of the performance of the communications system. The first distribution is configured to have the first variability per time point. The determining is configured to comprise: i) defining the subset of second time periods within the first time period. The second time periods in the subset are configured to be equally spaced in time over the first time period. The determining is configured to comprise: ii) determining the second variability of the second distribution (S) of the subset of the values. The subset of the values is configured to correspond to the subset of second periods configured to be defined. The determining is configured to comprise: v) detecting the presence of the anomalous value according to the threshold configured to be based on the variation along time of the second variability. The first node is also configured to provide the result of the determination of whether or not the anomalous value is present in the first distribution of values.

By the first node determining whether or not an anomalous value is present in the first distribution of values (M) over the first time period according to the threshold configured to be based on the second variability, the first node may be enabled to consider a time-varying variability, e.g., range, for each timestamp, as observed to vary seasonally. This may be understood to allow the method to take into consideration, for determining whether a value may be anomalous or not, the expected range of values that may be dependent on the time for which they may be approximated. This may be understood to in turn enable the first node to perform a more accurate detection of anomalous values, and thereby enable to take action on the performance of the communications system only when necessary, avoiding unnecessary interventions in the operations of the network, and conversely, detecting required interventions sooner than with existing methods.

### BRIEF DESCRIPTION OF THE DRAWINGS

Examples of embodiments herein are described in more detail with reference to the accompanying drawings, and according to the following description.

FIG. 1 is a schematic diagram illustrating an example of an AD pipeline, according to existing methods.

FIG. 2 is a schematic diagram illustrating two non-limiting embodiments, in panel a) and panel b) a communications system, according to embodiments herein.

FIG. 3 is a flowchart depicting a method in a first node, according to embodiments herein.

FIG. 4 is a schematic diagram illustrating a non-limiting example of an aspect of the method performed by the first node, according to embodiments herein.

FIG. 5 is a schematic diagram illustrating a non-limiting example of the method performed by the first node, according to embodiments herein.

FIG. 6 is a graphical representation of a number of active uplink users over two months, to be analyzed by a method according to embodiments herein.

FIG. 7 is a graphical representation of the number of active uplink users over two months, analyzed with a method according to embodiments herein.

FIG. 8 is a schematic block diagram illustrating two non-limiting examples, a) and b), of a first node, according to embodiments herein.

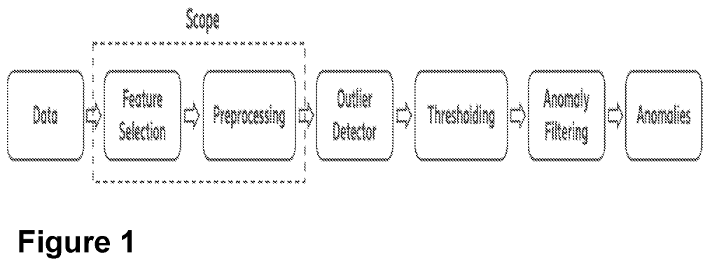

### DETAILED DESCRIPTION

Certain aspects of the present disclosure and their embodiments may provide solutions to the challenges discussed in the Background and Summary sections. There are, proposed herein, various embodiments which address one or more of the issues disclosed herein.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Note that although terminology from LTE/5G has been used in this disclosure to exemplify the embodiments herein, this should not be seen as limiting the scope of the embodiments herein to only the aforementioned system. Other wireless systems with similar features, may also benefit from exploiting the ideas covered within this disclosure.

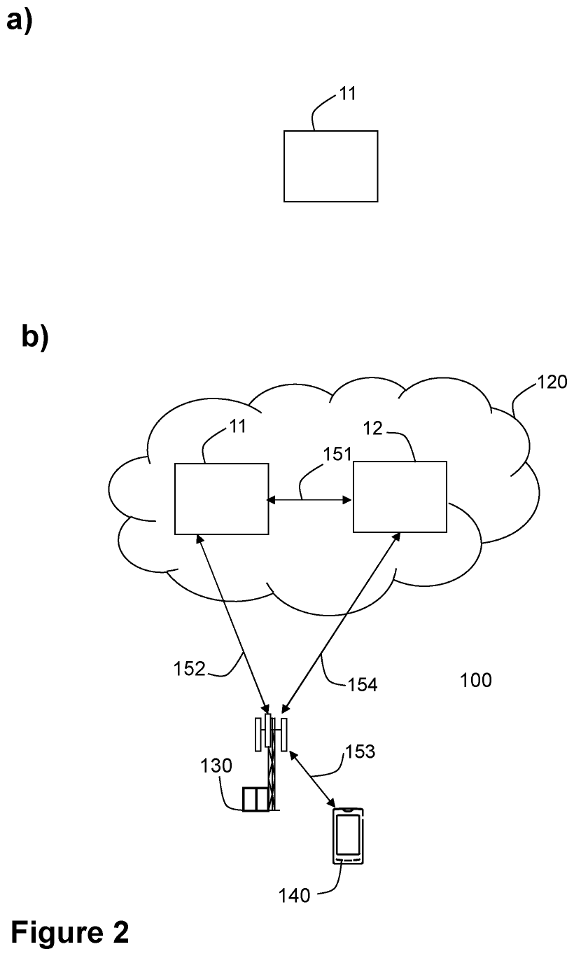

FIG. 2 is a schematic diagram depicting, in panel a), of a node, or first node 11, which may perform a method according to embodiments herein. The first node 11 may be understood as a first computer system or server. The first node 11 may be understood to have a capability to obtain, by retrieval from an internal memory, an external database, or a live or periodical feed from another node, such as a second node 12, data comprising values being indicative of a performance of a communications system 100. The second node 12, which may be understood to be a second computer system or server is depicted in the schematic diagram depicted in panel b).

Panel b) of FIG. 2 a non-limiting example of the communications system 100. In the non-limiting example depicted in panel b) of FIG. 2, the first node 11 and the second node 12 are both comprised in the communications system 100, in which embodiments herein may be implemented. However, this may be understood to not be necessary, as the first node 11 may perform the method according to embodiments herein as an external node, receiving data collected in the communications system 100. In some example implementations, the communications system 100 may be a computer network. In other example implementations, such as that depicted in the non-limiting example of FIG. 2, panel b), the communications system 100 may be a telecommunications network, sometimes also referred to as a cellular radio system, cellular network or wireless communications system. In some examples, the telecommunications network may comprise network nodes which may serve receiving nodes, such as wireless devices, with serving beams.

In some examples, the telecommunications network may for example be a network such as 5G system, or Next Gen network or an Internet service provider (ISP)-oriented network. The telecommunications network may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

Any of the first node 11 and the second node 12, may be implemented as a standalone server in e.g., a host computer in the cloud 120. In other examples, any of the first node 11 and the second node 12 may be a distributed node or distributed server, such as a virtual node in the cloud 120, and may perform some of its respective functions locally, e.g., by a client manager, and some of its functions in the cloud 120, by e.g., a server manager. In other examples, any of the first node 11 and the second node 12, may perform its functions entirely on the cloud 120, or partially, in collaboration or collocated with a radio network node. Yet in other examples, any of the first node 11 and the second node 12, may also be implemented as processing resource in a server farm. Any of the first node 11 and the second node 12, may be under the ownership or control of a service provider, or may be operated by the service provider or on behalf of the service provider.

The first node 11 may have the capability to determine, e.g., derive or calculate, one or more mathematical models, which may be stored, in a respective database or memory.

In fact, in some examples, any of the first node 11 and the second node 12 may be co-located or be the same node. In typical embodiments, any of the first node 11 and the second node 12 may be located in the cloud 120, as depicted in the examples of FIG. 2, and the first node 11 and the second node 12 may be located in a separate location geographically.

It may be understood that the communications system 100 may comprise additional nodes.

The capabilities and functions of each of these nodes will be described later, along with the description of the method performed by the first node 11.

The communications system 100 may comprise one or more radio network nodes, whereof a radio network node 130 is depicted in FIG. 2b. The radio network node 130 may typically be a base station or Transmission Point (TP), or any other network unit capable to serve a wireless device or a machine type node in the communications system 100. The radio network node 130 may be e.g., a 5G gNB, a 4G eNB, or a radio network node in an alternative 5G radio access technology, e.g., fixed or WiFi. The radio network node 130 may be e.g., a Wide Area Base Station, Medium Range Base Station, Local Area Base Station and Home Base Station, based on transmission power and thereby also coverage size. The radio network node 130 may be a stationary relay node or a mobile relay node. The radio network node 130 may support one or several communication technologies, and its name may depend on the technology and terminology used. The radio network node 130 may be directly connected to one or more networks and/or one or more core networks.

The communications system 100 covers a geographical area which may be divided into cell areas, wherein each cell area may be served by a radio network node, although, one radio network node may serve one or several cells.

The communications system 100 comprises a device 140. The device 140 may be also known as e.g., user equipment (UE), a wireless device, mobile terminal, wireless terminal and/or mobile station, mobile telephone, cellular telephone, or laptop with wireless capability, or a Customer Premises Equipment (CPE), just to mention some further examples. The device 140 in the present context may be, for example, portable, pocket-storable, hand-held, computer-comprised, or a vehicle-mounted mobile device, enabled to communicate voice and/or data, via a Radio Access Network (RAN), with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, sensor, Laptop Embedded Equipped (LEE), Laptop Mounted Equipment (LME), USB dongles, or any other radio network unit capable of communicating over a radio link in the communications system 100. The device 140 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100. In some particular embodiments, the device 140 may be an IoT device, e.g., a NB IoT device.

The first node 11 may communicate with the second node 12 over a first link 151. The first node 11 may communicate with the radio network node 130 over a second link 152. The radio network node 130 may communicate with the device 140 over a third link 153. The second node 12 may communicate with the radio network node 130 over a fourth link 154.

Any of the first link 151, the second link 152 and the third link 153, just described may be e.g., a radio link, an infrared link, or a wired link.

Any of the links described may be a direct link or may be comprised of a plurality of individual links, wherein it may go via one or more computer systems or one or more core networks, which are not depicted in FIG. 2, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 2.

In general, the usage of “first”, “second”, “third” and/or “fourth” herein may be understood to be an arbitrary way to denote different elements or entities, and may be understood to not confer a cumulative or chronological character to the nouns they modify, unless otherwise noted in the text.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

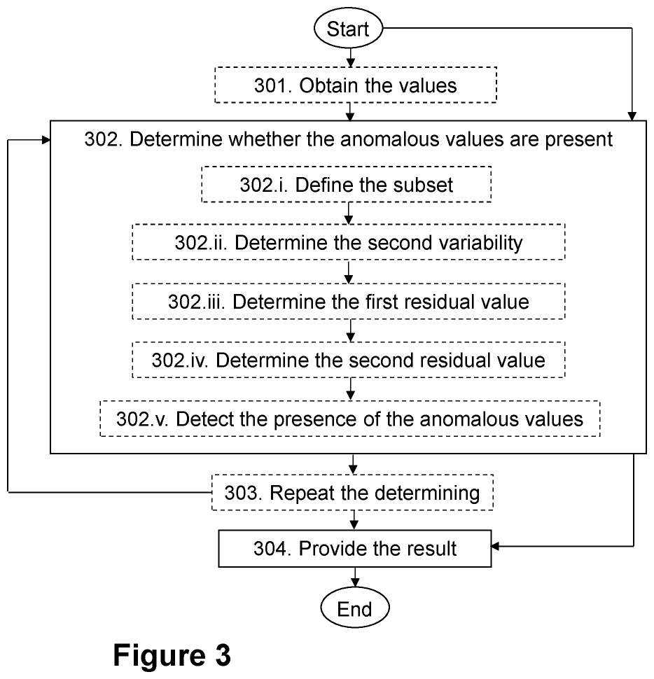

Embodiments of a computer-implemented method, performed by the first node 11, will now be described with reference to the flowchart depicted in FIG. 3. The method may be understood to be for handling anomalous values. The first node 11 may be operating in the communications system 100.

The method may comprise the actions described below. In some embodiments some of the actions may be performed. In some embodiments, all the actions may be performed. In FIG. 3, optional actions are indicated with dashed boxes. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

### Action 301

In the course of operations in the communications system 100, a number of metrics or variables may be registered, so that values (M) indicative of some aspect of a performance of the communications system 100 may be generated, e.g., by the device 140, and other devices like it, and/or by the radio network node 130 and other radio network nodes like it, which may be operating in the communications system 100. As a non-limiting example, the values (M) may be indicative of a KPI, such as Active Uplink Users.

The aim of embodiments of the method described herein may be understood to be to identify any of the obtained values that may be anomalous, and that may therefore hint that the performance of the communications system 100 may not be as expected. The values may be understood to be generated, registered or collected, over time, and hence to form a distribution of values over time, e.g., spanning over a number of weeks. This may be referred to herein as a first distribution of values (M), which may span over a first time period. The first time period may span a plurality of time points.

In order to determine the presence or not of anomalous values, the first node 11 in this Action 301, may first obtain values for every time point in the first distribution. Obtaining may be understood as e.g., collecting, recording, retrieving, gathering, and/or receiving, and may be performed via the first link 151, or the second link 152. The obtaining may be online, offline, continuous or periodic. Particular embodiments herein may be designed for a rolling feed of live data.

It may be understood that the first node 11 may obtain the values via yet another node in the communications system 100, which other node may be between the first node 11 and the radio network node 130.

By obtaining the values in this Action 301, the first node 11 may be enabled to then determine, in the next Action 302, whether or not any anomalous values may be present.

### Action 302

In this Action 302, the first node 11 determines whether or not an anomalous value is present in the first distribution of values (M) over the first time period. The first distribution of values (M) may be understood to correspond to the values obtained in Action 301. As stated earlier, the values are indicative of the performance of the communications system 100.

Determining may be understood as calculating, deriving, or similar.

The first time period may be, e.g., one month.

The first distribution of values (M) may have, a first variability per time point, of the plurality of time points that may be comprised in the first time period. The first variability may be understood to be a first range of values, for a certain point in time, e.g., time of the day. That is, how much the values may vary, may depend on the time point of interest. For example, at 8 PM the values may vary a lot from one day to the next, whereas, at 3 AM, the variability may be lower. As a simplified overview, the first node 11 may be understood to take this variation into account when determining whether or not one or more anomalous values are present in the first distribution of values (M) over the first time period in this Action 302, as described in the next subactions.

### i) Defining a Subset of Second Time Periods

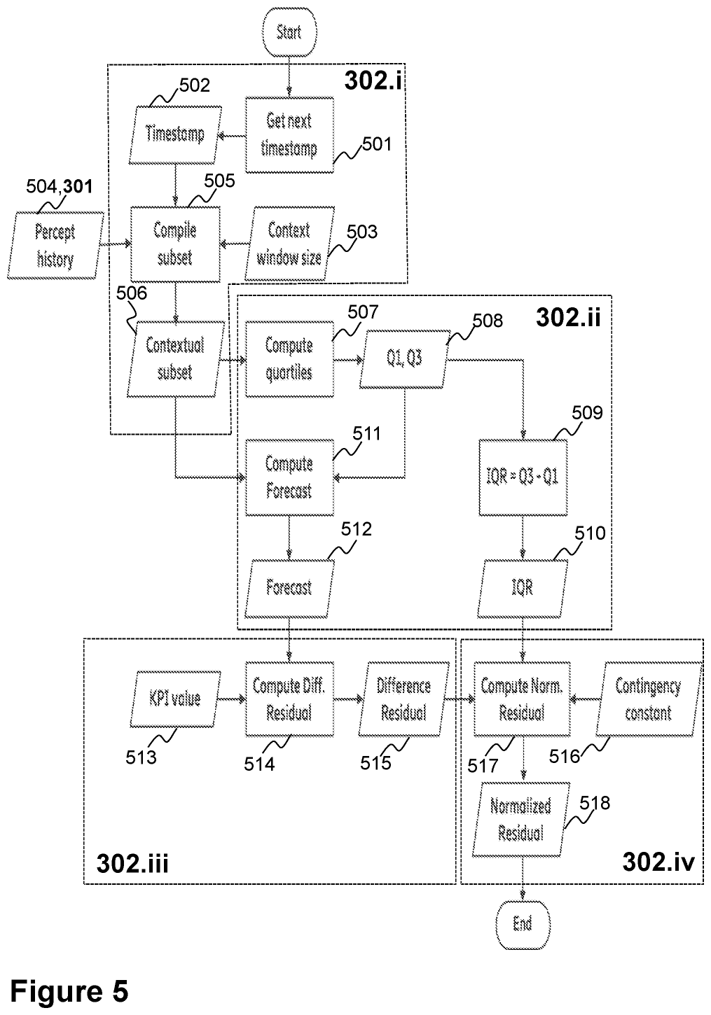

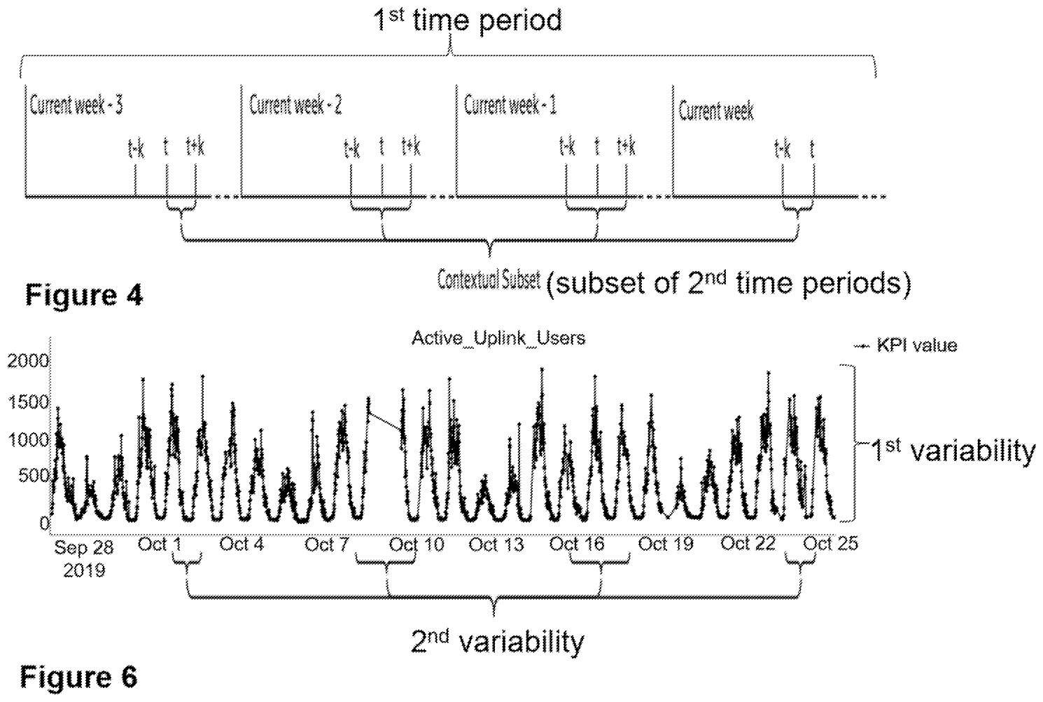

In general terms, embodiments herein may be understood to be drawn to the analysis of the presence of anomalous values based on a seasonal decomposition of the first distribution of values (M). More particularly, according to embodiments herein, the analysis of the presence or not of anomalous values may be performed, instead of using the entire pool of values within the first distribution at a time, by looking at how the values may vary for a same time point, e.g., an hour of a weekday, at different periodicities, e.g., weekly. In other words, according to embodiments herein, the analysis of the presence or not of anomalous values may be performed, instead of using the entire pool of values within the first distribution at a time, by looking at how the values may vary over a subset of time periods comprised within the span of the first time period, which time periods may be equally spaced in time over the first time period, and may be expected to be comparable, for a certain use case. These subset of equally spaced time periods comprised in the first time period are referred to herein as “second time periods”. For example, if the first time period spans over four weeks, the second time periods, may span a window within each week of the four weeks. The subset of equally spaced time periods may be referred to herein as a “contextual subset”. The contextual subset is graphically represented in FIG. 4, described later.

According to the foregoing, the determining in this Action 302 comprises i) defining a subset of second time periods within the first time period, the second time periods in the subset being equally spaced in time over the first time period. The defining of the subset of second time periods within the first time period, may be understood to be done for a first value (t) which first value (t) may define a time point of interest.

As part of this subaction i), for every week, the first value (t) may define the time point of interest, this may be a time of the day, such as e.g., 8 PM. The first value (t) may be identified by, or correspond to, e.g., a timestamp. The first value (t) may be provided as input to the first node 11.

A second value (k) may define a time window on at least one side of the first value (t) for every second time period in the subset. That is, the time window may be one of: t+k, t−k and t±k.

The second time periods may be understood to define a second distribution (S) of a subset of the values (M) corresponding to the defined subset of second periods, that is the part of the first distribution of values (M) falling under the second time periods.

In some embodiments, each of the second time periods may define a time window of a same time of the day, on the same day of the week, over 4 weeks, as depicted in the example of FIG. 4.

According to embodiments herein, for every time t, and for embodiments wherein the first time period may span one month, the second distribution (S) of the subset of the values over the second time periods may comprise: t+k in a first week, t±k in a second week and a third week, and t−k in a fourth week, see FIG. 4. This may be understood to be because, in the last month, if it is a current month, it may only be possible to take values from time t−k up to t−1.

According to the foregoing, as depicted in FIG. 4, the defining in this subaction i) may comprise, for each timestamp (t), for a one month history of a given KPI (M), and a second value (k) provided as input, compiling the contextual subset (S), from history, of a total of 6k+3 samples, by selecting:
a) M(t−k) through M(t−1) in the current week,
b) M(t−k) through M(t+k) for the same day of the last two weeks; and
c) M(t) through M(t+k) for the same day three weeks ago.

That is, for each timestamp, t, for a given day, the first node 11 may build a contextual subset by taking values between ±k periods, e.g., k=1.5 hours, for the same day for the past three weeks.

### ii) Determining the Variation of the First Variability

The determining in this Action 302 also comprises ii) determining a second variability of the second distribution (S) of the subset of the values, the subset of the values corresponding to the defined subset of second periods. The second variability of the second distribution may be understood to refer to the variability of the second distribution, wherein “second” is used to distinguish it from the “first variability”. In some examples, determining the second variability in this subaction ii) may comprise determining one or more quartiles for the second distribution (S). In particular embodiments, determining the second variability in this subaction ii) of Action 302, may comprise, ii.1) computing a first quartile (Q1), that is, the 25th percentile) and a third Quartile (Q3), that is, the 75th percentile, of the second distribution (S). That is, computing the quartiles, Q1 and Q3, from the contextual subset.

In some examples, determining the second variability in this subaction ii) may further comprise ii.2) determining a value, e.g., following the nomenclature herein, this would be a third value, indicative of the second variability of the second distribution (S) of the subset of the values over the subsets of second time periods. This value, or third value, may be a range between the third Quartile (Q3) and the first quartile (Q1) the second distribution (S) as an interquartile range (IQR) for t (IQR(t)), that is, as the range of values between Q3 and Q1, calculated as follows:

IQR(t)=Q3(t)−Q1(t)

The interquartile range, IQR=Q3−Q1, may be understood to become the expected deviation for timestamp t.

In some examples, determining the second variability in this subaction ii) may further comprise ii.3) determining a mean value of the subset of the values corresponding to the subset of second time periods, as an average of the range of values between the first quartile (Q1) and the third quartile (Q3). This mean may be referred to herein as the forecast for the first value (t) or forecast(t), as follows:

forecast(t)=mean({x┤|x∈S and Q1<x<Q3})

In other words, the mean of the values that lie between these quartiles may be understood as the forecast for timestamp t.

By taking the mean of the values within the IQR, that is, the values between Q1 and Q3, as the forecast, the possible outliers in the contextual subset may be eliminated.

iii) Determining the Residual Value

In order to detect the presence of the anomalous value, the determining in this Action 302 may comprise, iii) for each observed value within the subset of second time periods, determining a first residual value between the observed value (M(t)) and the mean value of the subset of the values corresponding to the subset of second time periods. The residual value may be referred to herein as a difference_residual(M,t), calculated as follows:

difference_residual(M,t)=M(t)−forecast(t)

### iv) Normalizing the Determined Residual Value

In order to detect the presence of the anomalous value, the determining in this Action 302 may comprise iv) for each observed value (M(t)) within the subset of second time periods, determining a second residual value by normalizing the determined first residual value by the value, that is, the third value, indicative of the second variability. The value indicative of the second variability may be the difference of the third quartile (Q3) minus the first quartile (Q1) of the second distribution (S) of the subset of the values over the second time periods referred to herein as IQR(t).

In some embodiments, the normalizing in this subaction iv) may comprise adding a constant (c) to the value, that is, the third value, so that the normalized values may exclude zero.

According to the foregoing, the normalizing in this subaction iv) may be performed as follows:

$$( M , t ) = \frac{M ( l ) - forecast ( t )}{IQR ( t ) + c}$$

By normalizing the determined residual values in the subset of second time periods, the first node 11 may be enabled to determine the time-varying range information for the values for each time point, corresponding to a particular timestamp (t), and thereby take this variability into account to determine whether or not a particular value may be anomalous or not. The normalized residual in this context may be understood to normalize the obtained residual with respect to the expected range at a given point of time. The contingency constant (c) may be understood to eliminate the possibility of a divide-by-zero error should both estimated bounds become the same, i.e., when IQR=0.

According to the foregoing, in particular embodiments herein, the first node 11 may be understood to perform a quartile-based seasonality decomposition (QBSD), which may be understood to address both daily and weekly seasonality by assessing the historical patterns of data over the past month. Embodiments herein may be understood to be designed for a rolling forecast on live data, as obtained in Action 301.

According to the foregoing subsections iii) and iv) two residuals may be calculated through the method performed by the first node 11, namely, the difference residual in subaction iii) and the normalized residual in subaction i). Either of them may be used based on the requirements of the use case. However, it may be noted that the time-varying range information may only be captured by the normalized residual.

### v) Detecting Anomalous Values

The determining in this Action 302 further comprises v) detecting the presence of the anomalous value according to a threshold based on the second variability. In other words, based on the expected range of deviation at the time of interest.

The detecting (v) of the presence of the anomalous value may be based on at least one of the determined first residual value and the second residual value. That is, depending on the requirement of a particular use case, the input to the anomaly detector performed by the first node 11, may be one of the two residuals: a) the usual difference residual between forecasted and predicted value for the corresponding timestamp t, as described in subaction iii), and b) the normalized residual, with may be understood to be the difference residual divided by the IQR for the corresponding timestamp t, as described in subaction iv).

The embodiments herein may be understood to implicitly handle seasonal variations, cyclic fluctuations and irregular variations: However, secular trend may be understood to not be considered. The method performed by the first node 11 may be understood to be specially designed for time series data which may assume a constant secular trend and that a change in trend may be potentially anomalous.

By determining whether the anomalous value is present in the first distribution of values (M) over the first time period, appropriate decisions may then be enabled to be performed in order to address the detected anomaly. For example, cells in the communications system 100 may be understood to be limited in resources, an increasing trend in RAN KPIs may therefore be used to make appropriate deployment modifications in order to address the detected anomalies.

### Action 303

In this Action 303, the first node 11, may then repeat the determining of Action 302 of whether or not an anomalous value is present in the first distribution of values (M), for every time point (t) in the first distribution. In other words, the first node 11 may repeat the procedure for the other time points, e.g., timestamps, in the first distribution other than the first time point.

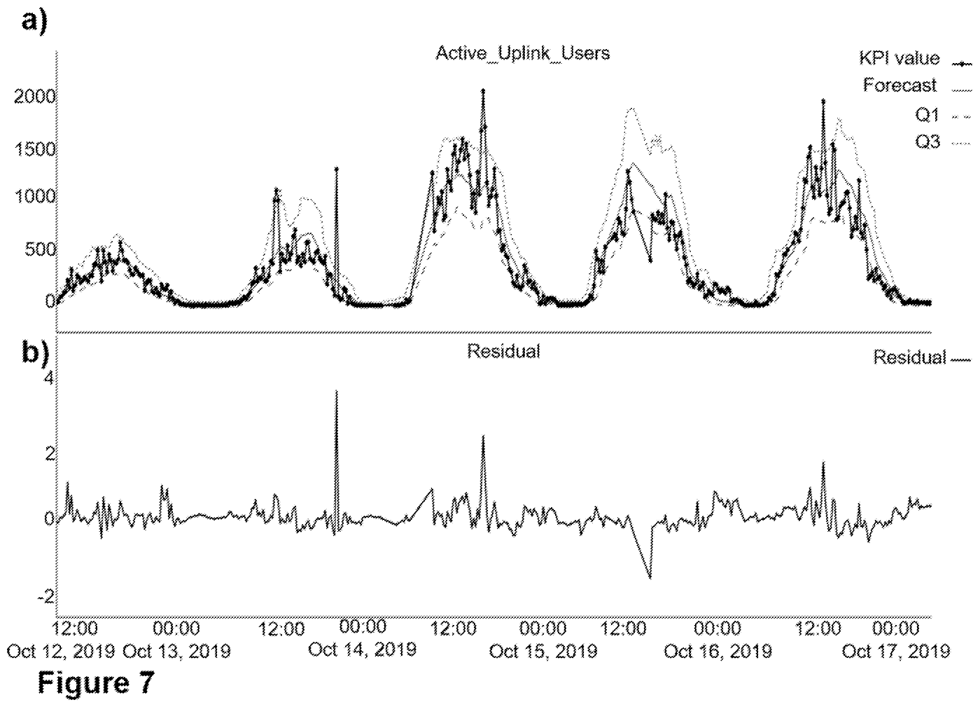

In embodiments wherein this Action 303 may be performed, the determining of Action 302 may comprise determining whether or not one or more anomalous values are present in the first distribution of values (M) over the first time period. Furthermore, the detecting of Action 302. v may comprise detecting the presence of the one or more anomalous values according to the threshold. In such embodiments, the threshold may be based on a variation along time of the second variability. That is, the threshold may be adjusted, or modified, once the distribution of the first residual and/or the second residual for all the time points (t) in the first period may have been determined, as is illustrated herein in part in the example of FIG. 7b) described later.

The performance of Action 303 may be understood to detect the presence of the one or more anomalous values at any time point of the first distribution of values (M).

### Action 304

In this Action 304, the first node 11 provides a result of the determination of whether or not the anomalous values is present in the first distribution of values.

Providing may be understood as e.g., outputting itself or sending or transmitting.

In some embodiments, the providing in this Action 304 of the result may be to the second node 12, e.g., by sending an indication via the first link 151. The indication may indicate one or more of the Q1, the Q3, the IQR, the forecast and the selected residual for the use case.

In embodiments wherein Action 303 may have been performed, in this Action 304, the first node 11 may provide a result of the determination of whether or not the one or more anomalous values are present in the first distribution of values.

By determining whether or not one or more anomalous values are present in the first distribution of values (M) over the first time period and then providing the result of the determination, appropriate decisions may be enabled to be performed in order to address the detected anomaly.

The scope of the embodiments described herein may be understood to be a seasonal decomposition which may concern the feature selection and preprocessing segments of the Anomaly Detection Pipeline, more specifically, seasonality decomposition. More particularly, according to the foregoing, embodiments herein may be understood to relate to a Quartile-Based Seasonality Decomposition.

The use case considered herein is AD in network Key Performance Indicators (KPIs). Two main challenges are considered: accurate forecasting and time-varying range estimation.

FIG. 4 is a schematic diagram illustrating a non-limiting example the contextual subset compilation according to embodiments herein. Time (t) is the timestamp for which the forecast and residuals are to be generated. While the first node 11 may sample all values from time t−k up to t+k for the past two weeks, it may only consider t to t+k for the third week. The sampling may be performed so that no time period may have an additional overlap bias while calculating the quartiles. The contextual subset compilation comprises, from right to left: M(t−k) through M(t−1) in the current week, M(t−k) through M(t+k) for the same day of the last two weeks; and M(t) through M(t+k) for the same day three weeks ago.

FIG. 5 is a flowchart illustrating a non-limiting example of the Quartile Based Seasonality Decomposition (QBSD) method according to embodiments herein. This chart includes the steps involved to generate the expected bounds, that is, the quartiles, forecast and residuals for a single timestamp, according to Action 302. This process may be looped for every incoming timestamp in production, according to Action 303. Embodiments herein may be understood to advantageously perform AD based on how the QBSD forecast and normalized residual may be calculated for a given timestamp. For this non-limiting example, M(t) is the value of the KPI, M at time t. At 501, the first node 111 may get the next timestamp, which may then be defined at 502, according to Action 302i), as the first value (t) defining a first time point of interest. At 503, and according to Action 302i), the first node 11 may define the second value (k) as the time window on at least one side of the first value (t) for every second time period in the subset. At 504, in accordance with Action 301, the first node 11 may obtain the values for every time point in the first distribution as the percept history. Hence, the input to the performance of the method may be: timestamp (t), 1 month history of KPI (M), and context window size, (k). For each timestamp (t) for a given KPI (M), the first node 11 may, at 505, according to Action 302ii), compile the contextual subset (S), from the history, e.g., the total of 6k+3 samples, by selecting: a) M(t−k) through M(t−1), b) M(t−k) through M(t+k) for the same day of the last two weeks and c) M(t) through M(t+k) for the same day three weeks ago. At 506, and according to Action 302ii), the first node 11 may obtain the contextual subset. At 507, and according to Action 302iii), the first node 11 may calculate the quartiles Q1 and Q3 of the subset, which it may obtain at 508, and hence, at 509, find IQR=Q3−Q1, which it may obtain at 510. At 511, and according to Action 302ii), the first node 11 may compute the forecast as forecast(t)=mean({x┤|x∈S and Q1<x<Q3}), which it then may obtain at 512. At 513, and according to Action 302iii), the first node 11 may obtain a KPI value of interest, and, at 514, and according to Action 302iii), compute the difference residual as difference_residual(M,t)=M(t)−forecast(t), which it then may obtain at 515. At 516, and according to Action 302iv), the first node 11 may obtain the contingency constant (c), and based on it, at 517, and according to Action 302iv), compute the normalized residual as normalized_residual(M,t)=(M(t)−forecast(t))/(IQR(t)+c), which it then may obtain at 518. Action 302 may then end, and although not depicted in FIG. 5, the first node 11 may then, according to Action 304, return the following: Q1, Q3, and IQR, forecast and the selected residual for the use case.

FIG. 6 is a graphic representation illustrating a non-limiting example of sample input data, according to embodiments herein, particularly, of the first distribution of (M). This sample includes a snapshot of the Active Uplink Users KPI, in the vertical axis, over two months, the time points of which are depicted in the horizontal axis. Only four weeks are shown here for simplicity. It may be noted how the data follows both daily and weekly seasonal patterns. The cyclic pattern that occurs every day depicts daily seasonality. The periodic pattern of five consecutive daily peaks, corresponding to weekdays, followed by two smaller peaks, corresponding to weekends, depict weekly seasonality. Also, it may be noted that this dataset contains missing data, e.g., between October 8, 12:30 and October 9, 15:45. Nevertheless, there are enough samples for the previous weeks for the same period to accurately estimate their forecast and range for that period.

FIG. 7 is a graphic representation illustrating a non-limiting example of QBSD data, according to embodiments herein. Consider data from the Active Uplink Users KPI, as shown in FIG. 6, which includes both daily and weekly seasonality. This data is passed through the QBSD method performed by the first node 11 to illustrate the seasonality decomposition. For this example, the context window size is k=6, and the contingency constant is c=1. FIG. 7 shows the sample output, that is, any of Q1, Q3 and the forecast, of the method. The output compares, as represented in panel a), the QBSD forecast, depicted by the solid lines with no dots, with the real observed KPI data, depicted by the solid lines with black dots, along with, as represented in panel b), the generated normalized residual. Panel a) also depicts the Q1, represented by the lines with long dashes, and Q3, represented by the solid lines with short dashes. The sample output shows Q1, which is the lower bound, and Q3, which is the upper bound. The sample output shows that the method performed by the first node 11 captures the lower and upper bound effectively. That is, the QBSD according to embodiments herein may predict the lower and upper bounds accurately, following the time series. The range between the expected lower and upper bound is also different at different points of the day. It may be noted that it is narrower around midnight and broader during the day. The forecast also adequately approximates the expected value of the KPI. Forecast may be understood as the average of all values in the second distribution that lies between Q1 and Q3. An expected value may be understood as a value that falls in the expected range of values. The expected range is Q1 and Q3, wherein Q1 is the lower expected range and Q3 is the upper expected range. The general notion is that any value that goes significantly beyond the expected range is probably an anomaly. In which case, the first two spikes and one dip may qualify as anomalies in this example. It may be noted that not all KPI values that exceed beyond the expected bounds may be considered to be anomalous. For instance, the third spike depicted in panel a) in this example goes just above the expected range, but the normalized residual shows that the peak is not significantly greater than the others as calculated in recent history. Hence, statistically, the third spike is not an anomaly, but this definition may differ from one use case to another based on the use case requirements. The severity of an anomaly in this case is inversely proportional to the expected range at the time of deviation. For example, even a moderate deviation at midnight may be considered to be anomalous, while during the day, the deviation may have to be significantly large for it to be called out as an anomaly. It may also be noted that the first spike, on October 13, 20:30, is significantly more anomalous than the second spike, on October 14, 16:00, even though the first spike is lower in magnitude that than the second. This phenomenon may be understood to be due to the seasonal range that is captured by the method according to embodiments herein, in addition to the expected forecast value. The dip on October 15, 14:15, is a left-tailed anomaly. The third spike on October 16, 13:15 is likely not to be anomalous, but may be understood to be debatable based on the use case.

As a summarized overview, embodiments herein may be understood to relate to and AD method based on a time-varying range estimation which may use only a single parameter, the second value or context window size (k) and one parameter for residual normalization, that is, the contingency constant (c). This may be understood to allow the method to approximate both the forecast and the expected range of values that may be dependent on the time for which they may be approximated. As of now, no system approximates this range based on a contextual subset as described in the proposed method.

One advantage of embodiments herein may be understood to be the simplicity of the procedure in handling the tuning of hyperparameters, as embodiments herein may be understood to not require complicated hyperparameter tuning. Advantageously, only two parameters may need to be used, that is, the context window size (k), and the contingency constant (c).

Another advantage of embodiments herein may be understood to be the increased accuracy of the AD process, as the normalized residual may consider the time-varying range for each timestamp.

A further advantage of embodiments herein may be understood to be that the same hyperparameter may perform equally well on nearly all cell traffic KPIs in practice.

Another advantage of embodiments herein may be understood to be that the rolling forecast model may be understood to not require a scheduled retraining, which also simplifies the hardware and computing resources involved.

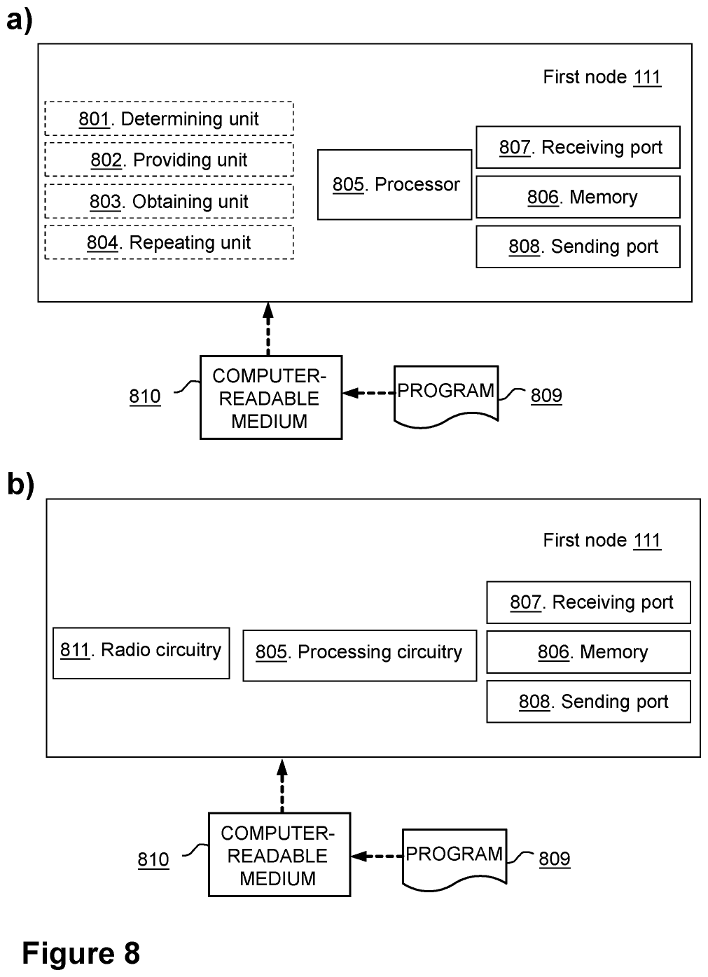

FIG. 8 depicts two different examples in panels a) and b), respectively, of the arrangement that the first node 11 may comprise to perform the method described in FIG. 3. In some embodiments, the first node 11 may comprise the following arrangement depicted in FIG. 8a. The first node 11 may be configured to operate in the communications system 100. The first node 11 may be understood to be for handling anomalous values.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. In FIG. 8, optional units are indicated with dashed boxes.

The detailed description of some of the following corresponds to the same references provided above, in relation to the actions described for the first node 11 and will thus not be repeated here. For example, the first value (t) may be configured to be identified by, e.g., a timestamp.

The first node 11 is configured to, e.g., by means of a determining unit 801 within the first node 11, configured to determine whether or not a value is present in the first distribution of values (M) over the first time period. The values are configured to be indicative of the performance of the communications system 100. The first distribution is configured to have the first variability per time point. The determining is configured to comprise: i) defining the subset of second time periods within the first time period, the second time periods in the subset being configured to be equally spaced in time over the first time period, ii) determining the second variability of the second distribution (S) of the subset of the values, the subset of the values being configured to correspond to the subset of second periods configured to be defined, and v) detecting the presence of the anomalous value according to the threshold configured to be based on the second variability.

The first node 11 is further configured to, e.g., by means of a providing unit 802 within the first node 11, configured to provide the result of the determination of whether or not the anomalous value is present in the first distribution of values.

In some embodiments, the determining of whether or not an anomalous value is present in the first distribution of values (M) may be further configured to comprise at least one of: iii) for each observed value (M(t)), within the subset of second time periods, determining the first residual value between the observed value (M(t)), and the mean value of the subset of the values corresponding to the defined subset of second time periods, and iv) for each observed value, (M(t)), within the subset of second time periods, determining the second residual value by normalizing the determined first residual value by the value indicative of the second variability. The detecting v) of the presence of the anomalous value may be configured to be based on at least one of the first residual value and the second residual value configured to be determined.

In some embodiments, the value may be configured to be the difference of the third quartile minus the first quartile of the second distribution (S), of the subset of the values over the second time periods.

In some embodiments, the mean value may be configured to be the average of the range of values between the first quartile and the third quartile.

In some embodiments, the normalizing may be configured to comprise adding the constant (c) to the value so that the normalized values exclude zero.

In some embodiments, each of the second time periods may be configured to define the time window of the same time of the day, on the same day of the week, over 4 weeks.

In some embodiments, the first node 11 may be further configured to, e.g., by means of an obtaining unit 803 within the first node 11, configured to obtain the values for every time point in the first distribution, wherein for every week, the first value t may be configured to define the time point of interest, and the second value k may be configured to define the time window on at least one side of the first value t for every second time period in the subset. The second distribution S of the subset of the values over the second time periods may be configured to comprise: t+k in a first week, t±k in a second week and a third week, and t−k in a fourth week.

In some embodiments, the first node 11 may be further configured to, e.g., by means of a repeating unit 804 within the first node 11, configured to repeat the determining of whether or not an anomalous value is present in the first distribution of values (M) for every time point in the first distribution.

In some embodiments, the providing of the result may be configured to be to the second node 12 configured to operate in the communications system 100.

In some embodiments, to determine may be configured to comprise to determine whether or not one or more anomalous values are present in the first distribution of values (M) over the first time period. To detect may be configured to comprise detecting the presence of the one or more anomalous values according to the threshold. The threshold may be configured to be based on the variation along time of the second variability.

The embodiments herein in the first node 11 may be implemented through one or more processors, such as a processor 805 in the first node 11 depicted in FIG. 11a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 11. One such carrier may be in the form of a CD ROM disc. It is however feasible with other data carriers such as a memory stick. The computer program code may furthermore be provided as pure program code on a server and downloaded to the first node 11.

The first node 11 may further comprise a memory 806 comprising one or more memory units. The memory 806 is arranged to be used to store obtained information, store data, configurations, schedulings, and applications etc. to perform the methods herein when being executed in the first node 11.

In some embodiments, the first node 11 may receive information from, e.g., any of the second node 112, the radio network node 130, and/or the device 140 through a receiving port 807. In some embodiments, the receiving port 807 may be, for example, connected to one or more antennas in first node 11. In other embodiments, the first node 11 may receive information from another structure in the communications system 100 through the receiving port 807. Since the receiving port 807 may be in communication with the processor 805, the receiving port 807 may then send the received information to the processor 805. The receiving port 807 may also be configured to receive other information.

The processor 805 in the first node 11 may be further configured to transmit or send information to e.g., any the second node 112, the radio network node 130, the device 140 and/or another structure in the communications system 100, through a sending port 808, which may be in communication with the processor 805, and the memory 806.

Those skilled in the art will also appreciate that the units 801-804 described above may refer to a combination of analog and digital circuits, and/or one or more processors configured with software and/or firmware, e.g., stored in memory, that, when executed by the one or more processors such as the processor 805, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 801-804 described above may be implemented as one or more applications running on one or more processors such as the processor 805.

Thus, the methods according to the embodiments described herein for the first node 11 may be respectively implemented by means of a computer program 809 product, comprising instructions, i.e., software code portions, which, when executed on at least one processor 805, cause the at least one processor 805 to carry out the actions described herein, as performed by the first node 11. The computer program 809 product may be stored on a computer-readable storage medium 180. The computer-readable storage medium 180, having stored thereon the computer program 809, may comprise instructions which, when executed on at least one processor 805, cause the at least one processor 805 to carry out the actions described herein, as performed by the first node 11. In some embodiments, the computer-readable storage medium 180 may be a non-transitory computer-readable storage medium, such as a CD ROM disc, or a memory stick. In other embodiments, the computer program 809 product may be stored on a carrier containing the computer program 809 just described, wherein the carrier is one of an electronic signal, optical signal, radio signal, or the computer-readable storage medium 180, as described above.

The first node 11 may comprise a communication interface configured to facilitate, or an interface unit to facilitate, communications between the first node 11 and other nodes or devices, e.g., any the second node 112, the radio network node 130, the device 140 and/or another structure in the communications system 100. The interface may, for example, include a transceiver configured to transmit and receive radio signals over an air interface in accordance with a suitable standard.

In other embodiments, the first node 11 may comprise the following arrangement depicted in FIG. 8b. The first node 11 may comprise a processing circuitry 805, e.g., one or more processors such as the processor 805, in the first node 11 and the memory 806. The first node 11 may also comprise a radio circuitry 811, which may comprise e.g., the receiving port 807 and the sending port 808. The processing circuitry 805 may be configured to, or operable to, perform the method actions according to FIG. 3, FIG. 4, FIG. 5, FIG. 6, and/or FIG. 7, in a similar manner as that described in relation to FIG. 8a. The radio circuitry 811 may be configured to set up and maintain at least a wireless connection with the any the second node 112, the radio network node 130, the device 140 and/or another structure in the communications system 100. Circuitry may be understood herein as a hardware component.

Hence, embodiments herein also relate to the first node 11 operative to operate in the communications system 100. The first node 11 may comprise the processing circuitry 805 and the memory 806, said memory 806 containing instructions executable by said processing circuitry 805, whereby the first node 11 is further operative to perform the actions described herein in relation to the first node 11, e.g., in FIG. 3, FIG. 4, FIG. 5, FIG. 6, and/or FIG. 7.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES LIST

1. Overview of Time Series Characteristics, Penn State Eberly College of Science, link: https://online.stat.psu.edu/stat510/lesson/1/1.1
2. Forecasting: Principles and Practice, Rob J Hyndman and George Athanasopoulos. Section 6.6 STL Decomposition, link: https://otexts.com/fpp2/stl.html
3. Forecasting: Principles and Practice, Rob J Hyndman and George Athanasopoulos. Section 8.9 Seasonal ARIMA Models, link: https://otexts.com/fpp2/seasonal-arima.html
4. Using ARIMA for Time Series Analysis, David Abugaber, University of Chicago, link: https://ademos.people.uic.edu/Chapter23.html
5. Forecasting: Principles and Practice, Rob J Hyndman and George Athanasopoulos. Section 7.3 Holt Winters' Seasonal Method, link: https://otexts.com/fpp2/holt-winters.html
6. Time Series. In: The Concise Encyclopedia of Statistics. Springer, New York, NY. Link: https://doi.org/10.1007/97B-0-387-32833-1_401

1. A computer-implemented method, performed by a first node, for handling anomalous values, the method comprising:
determining whether or not an anomalous value is present in a first distribution of values (M) over a first time period, the values being indicative of a performance of a communications system, and the first distribution having a first variability per time point, the determining comprising:
i. defining a subset of second time periods within the first time period, the second time periods in the subset being equally spaced in time over the first time period,
ii. determining a second variability of a second distribution (S) of a subset of the values, the subset of the values corresponding to the defined subset of second periods, and
v. detecting the presence of the anomalous value according to a threshold based on the second variability, and
providing a result of the determination of whether or not the anomalous value is present in the first distribution of values.

2. The computer-implemented method according to claim 1, wherein the determining of whether or not the anomalous value is present in the first distribution of values, M, further comprises at least one of:
iii. for each observed value (M(t)) within the subset of second time periods, determining a first residual value between the observed value (M(t)) and a mean value of the subset of the values corresponding to the defined subset of second time periods, and
iv. for each observed value (M(t)) within the subset of second time periods, determining a second residual value by normalizing the determined first residual value by a value indicative of the second variability,
and wherein the detecting of the presence of the anomalous value is based on at least one of the determined first residual value and the second residual value.

3. The computer-implemented method according to claim 2, wherein the value is a difference of a third quartile minus a first quartile of the second distribution (S) of the subset of the values over the second time periods.

4. The computer-implemented method according to claim 3, wherein the mean value is the average of a range of values between the first quartile and the third quartile.

5. The computer-implemented method according claim 2, wherein the normalizing comprises adding a constant (c) to the value, so that the normalized values exclude zero.

6. The computer-implemented method according claim 1, wherein each of the second time periods define a time window of a same time of the day, on the same day of the week, over 4 weeks.

7. The computer-implemented method according to claim 6, the method further comprising:
obtaining the values for every time point in the first distribution, wherein for every week, a first value, t, defines a time point of interest, and a second value, k, defines the time window on at least one side of the first value, t, for every second time period in the subset, and wherein the second distribution (S) of the subset of the values over the second time periods comprises: t+k in a first week, t±k in a second week and a third week, and t−k in a fourth week.

8. The computer-implemented method according to claim 1, wherein the method further comprises:
repeating the determining whether or not an anomalous value is present in the first distribution of values (M) for every time point in the first distribution.

9. The computer-implemented method according to claim 8, wherein the determining comprises determining whether or not one or more anomalous values are present in the first distribution of values (M) over the first time period, and wherein the detecting comprises detecting the presence of the one or more anomalous values according to the threshold, wherein the threshold is based on a variation along time of the second variability.

10. The computer-implemented method according to claim 1, wherein the providing of the result is to a second node operating in the communications system.

11. A computer program, comprising instructions which, when executed on at least one processor, cause the at least one processor to carry out the method according to claim 1.

12. A computer-readable storage medium, having stored thereon a computer program, comprising instructions which, when executed on at least one processor, cause the at least one processor to carry out the method according to claim 1.

13. A first node, for handling anomalous values, the first node being configured to:
determine whether or not an anomalous value is present in a first distribution of values (M) over a first time period, the values being configured to be indicative of a performance of a communications system, and the first distribution being configured to have a first variability per time point, the determining being configured to comprise:
iii. defining a subset of second time periods within the first time period, the second time periods in the subset being configured to be equally spaced in time over the first time period,
iv. determining a second variability of a second distribution (S) of a subset of the values, the subset of the values being configured to correspond to the subset of second periods configured to be defined, and
v. detecting the presence of the anomalous value according to a threshold configured to be based on the second variability, and
provide a result of the determination of whether or not the anomalous value is present in the first distribution of values.

14. The first node according to claim 13, wherein the determining of whether or not the anomalous value is present in the first distribution of values (M) is further configured to comprise at least one of:
iii. for each observed value (M(t)) within the subset of second time periods, determining a first residual value between the observed value (M(t)) and a mean value of the subset of the values corresponding to the defined subset of second time periods, and
iv. for each observed value (M(t)) within the subset of second time periods, determining a second residual value by normalizing the determined first residual value by a value indicative of the second variability,
and wherein the detecting of the presence of the anomalous value is configured to be based on at least one of the first residual value and the second residual value configured to be determined.

15. The first node according to claim 14, wherein the value is configured to be a difference of a third quartile minus a first quartile of the second distribution (S) of the subset of the values over the second time periods.

16. The first node according to claim 15, wherein the mean value is configured to be the average of a range of values between the first quartile and the third quartile.

17. The first node according claim 14, wherein the normalizing is configured to comprise adding a constant (c), to the value so that the normalized values exclude zero.

18. The first node according claim 13, wherein each of the second time periods is configured to define a time window of a same time of the day, on the same day of the week, over 4 weeks.

19. The first node according to claim 18, the first node being further configured to:
obtain the values for every time point in the first distribution, wherein for every week, a first value, t, is configured to define a time point of interest, and a second value, k, is configured to define the time window on at least one side of the first value, t, for every second time period in the subset, and wherein the second distribution (S) of the subset of the values over the second time periods is configured to comprise: t+k in a first week, t±k in a second week and a third week, and t−k in a fourth week.

20. The first node according to claim 13, wherein the first node is further configured to:
repeat the determining of whether or not an anomalous value is present in the first distribution of values (M) for every time point in the first distribution.

21-22. (canceled)
